(19) United States
(12) Patent Application Publication
(10) Pub. No.: US 2019/0145304 A1
(43) Pub. Date: May 16, 2019

(54) ENGINE COOLANT CONTROL SYSTEMS AND METHODS USING MODEL PREDICTIVE CONTROL

(71) Applicant: GM Global Technology Operations LLC, Detroit, MI (US)

(72) Inventors: Gabriele GIRAUDO, Torino (IT); Vincenzo ALFIERI, Torino (IT); Michele BlLANCIA, Torino (IT); Nicola PISU, Canton, MI (US)

(73) Assignee: GM Global Technology Operations LLC, Detroit, MI (US)

(21) Appl. No.: 15/808,980

(22) Filed: Nov. 10, 2017

(51) Int. Cl. F01P 7/16; F01P 5/12; F01P 3/20; F01P 3/02; G05B 13/04; G05D 7/06

(52) U.S. Cl. CPC F01P 7/164; F01P 5/12; F01P 3/20; F01P 2007/146; G05B 13/048; G05D 7/0617; F01P 3/02

(57) ABSTRACT

A prediction module is configured to, based on a set of possible target values for future times, determine predicted efficiency values for set of possible target values at the future times, respectively. A cost module is configured to determine a cost for the set of possible target values based on comparisons of the predicted efficiency values and a reference efficiency value. A selection module is configured to: (i) based on the cost of the set of possible target values, select the set of possible target values from a group including: the set of possible target values; and N other sets of possible target values; and (ii) set target values to respective ones of the selected set of possible target values. A first valve control module is configured to actuate a first coolant valve based on a first one of the target values.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles with internal combustion engines and more particularly to systems and methods for controlling engine coolant flow.

An internal combustion engine combusts air and fuel within cylinders to generate drive torque. Combustion of air and fuel also generates heat and exhaust. Exhaust produced by an engine flows through an exhaust system before being expelled to atmosphere.

Excessive heating may shorten the lifetime of the engine, engine components, and/or other components of a vehicle. As such, vehicles that include an internal combustion engine typically include a radiator that is connected to coolant channels within the engine. Engine coolant circulates through the coolant channels and the radiator. The engine coolant absorbs heat from the engine and carries the heat to the radiator. The radiator transfers heat from the engine coolant to air passing the radiator. The cooled engine coolant exiting the radiator is circulated back to the engine.

### SUMMARY

In a feature, a coolant control system of a vehicle includes a prediction module configured to, based on a set of possible target values for M future times, determine M predicted efficiency values for set of possible target values at the M future times, respectively. M is an integer greater than or equal to one. A cost module is configured to determine a cost for the set of possible target values based on comparisons of the M predicted efficiency values and a reference efficiency value. A selection module is configured to: (i) based on the cost of the set of possible target values, select the set of possible target values from a group including: the set of possible target values; and N other sets of possible target values, where N is an integer greater than zero; and (ii) set target values to respective ones of the selected set of possible target values. A first valve control module is configured to actuate a first coolant valve based on a first one of the target values, where the first coolant valve is configured to control coolant flow through a portion of a coolant system of the vehicle.

In further features: a second valve control module is configured to actuate a second coolant valve based on a second one of the target values; a third valve control module is configured to actuate a third coolant valve based on a third one of the target values; and a pump control module is configured to apply power to an electric coolant pump based on a fourth one of the target values.

In further features, the first coolant valve is configured to regulate coolant flow through at least one of: an engine block portion of an internal combustion engine of the vehicle; and a cylinder head portion of the internal combustion engine of the vehicle.

In further features, the first coolant valve is configured to regulate coolant flow both of: an engine block portion of an internal combustion engine of the vehicle; and a cylinder head portion of the internal combustion engine of the vehicle.

In further features, the second coolant valve is configured to regulate coolant flow to at least one of: a radiator heat exchanger; and a passenger cabin heat exchanger.

In further features, the second coolant valve is configured to regulate coolant flow to both of: a radiator heat exchanger; and a passenger cabin heat exchanger.

In further features, the third coolant valve is configured to regulate coolant flow to at least one of: a transmission oil heat exchanger; and an engine oil heat exchanger.

In further features, the third coolant valve is configured to regulate coolant flow to both of: a transmission oil heat exchanger; and an engine oil heat exchanger.

In further features, the selection module is configured to select the set of possible target values from the group in response to a determination that the cost of the set of possible target values is less than all of N costs of the N other sets of possible target values, respectively.

In further features, the cost module is configured to increase the cost of the set of possible target values as a difference between one of the M predicted efficiency values and the reference efficiency value increases.

In further features, the cost module is configured to increase the cost of the set of possible target values as a magnitude of a difference between one of the M predicted efficiency values and the reference efficiency value increases.

In further features, the reference efficiency value is a fixed, predetermined value.

In further features, the prediction module is configured to: based on the set of possible target values for M future times, using a first mathematical model, determine N predicted coolant flowrates through N different branches of the coolant system through which coolant can flow at the M future times, where N is an integer greater than one; and based on the N predicted coolant flowrates at the M future times, determine the M predicted efficiency values for the set of possible target values using a second mathematical model.

In further features, the first mathematical model relates sets of the possible target values to sets of the N predicted coolant flowrates.

In further features, the second mathematical model relates sets of the N predicted coolant flowrates to individual predicted efficiency values.

In further features: the prediction module is further configured to, based on the set of possible target values for the M future times, determine M predicted coolant temperatures at a location within the coolant system for the M future times, respectively; and the cost module is configured to determine the cost for the set of possible target values further based on comparisons of the M predicted coolant temperatures and a reference coolant temperature at the location.

In further features, the reference coolant temperature is a predetermined amount less than a boiling point temperature of the coolant.

In further features, the prediction module is configured to: based on the set of possible target values for M future times, using a first mathematical model, determine N predicted coolant flowrates through N different branches of the coolant system through which coolant can flow at the M future times; and based on the N predicted coolant flowrates at the M future times, using a second mathematical model, determine the M predicted coolant temperatures for the set of possible target values.

In further features: the first mathematical model relates sets of the possible target values to sets of the N predicted coolant flowrates; and the second mathematical model relates sets of the N predicted coolant flowrates to individual predicted coolant temperatures.

In a feature, a coolant control method for a vehicle includes: based on a set of possible target values for M future times, determining M predicted efficiency values for set of possible target values at the M future times, respectively, where M is an integer greater than or equal to one; determining a cost for the set of possible target values based on comparisons of the M predicted efficiency values and a reference efficiency value; based on the cost of the set of possible target values, selecting the set of possible target values from a group including: the set of possible target values; and N other sets of possible target values, where N is an integer greater than zero; and setting target values to respective ones of the selected set of possible target values; and actuating a first coolant valve based on a first one of the target values, where the first coolant valve is configured to control coolant flow through a portion of a coolant system of the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system including a coolant system;

FIG. 2 is a functional block diagram of an example coolant control module;

FIG. 3 is a functional block diagram of an example prediction module; and

FIG. 4 is a flowchart depicting an example method of controlling coolant flow using model predictive control (MPC).

In the drawings, reference numbers may be reused to identify similar and/or identical elements.

### DETAILED DESCRIPTION

An engine combusts air and fuel to generate drive torque. Combustion generates heat. A coolant system circulates coolant through various portions of the engine, such as a cylinder head and an engine block, and through various other components of the vehicle. Coolant absorbs heat from the engine, engine oil, transmission fluid, and other components and releases heat to air.

A coolant control module controls positions of various coolant valves based on respective target positions and a speed of an electric coolant pump based on a target speed. The coolant control module could determine the targets individually using multiple single input single output (SISO) controllers (e.g., proportional integral derivative (PID) controllers). However, when multiple SISO controllers are used, sub-optimal targets may be set to maintain system stability at the expense of possible efficiency increases (e.g., fuel consumption decreases). Additionally, coordination, calibration and design of the individual SISO controllers may be costly and time consuming.

The coolant control module of the present disclosure collectively controls the coolant valves and the coolant pump using model predictive control (MPC). More specifically, the coolant control module collectively determines possible sets of targets for the coolant valves and the coolant pump. The coolant control module determines predicted parameters for each of the possible sets based on the target values of the possible sets. For example, the coolant control module determines predicted flowrates through different coolant branches based on the target values of the possible sets, respectively. The coolant control module may determine predicted efficiencies for each of the possible sets based on the flowrates of the possible sets, respectively.

The coolant control module determines costs associated with the use of the possible sets, respectively. The coolant control module determines the costs for the possible sets based on comparisons of the respective predicted parameters of the possible sets with respective reference parameters. For example, the coolant control module determines the cost of a possible set based on a comparison of the predicted efficiencies of the possible set with a reference efficiency. The coolant control module calculates the cost of the possible set as function of the difference between the predicted efficiency of the possible set and the reference efficiency. Possible sets of target values having higher efficiencies will have lower costs than possible sets of target values having lower efficiencies.

The coolant control selects a possible set, for example, the one of the possible sets that has the lowest cost. The coolant control module controls the coolant valves and the coolant pump based on the respective targets of the selected possible set. The coolant control module may therefore control coolant flow through the coolant branches to best track the reference efficiency. Because the reference efficiency may be set to a predetermined maximum value, the coolant control module may control coolant flow through the coolant branches to achieve a highest possible efficiency.

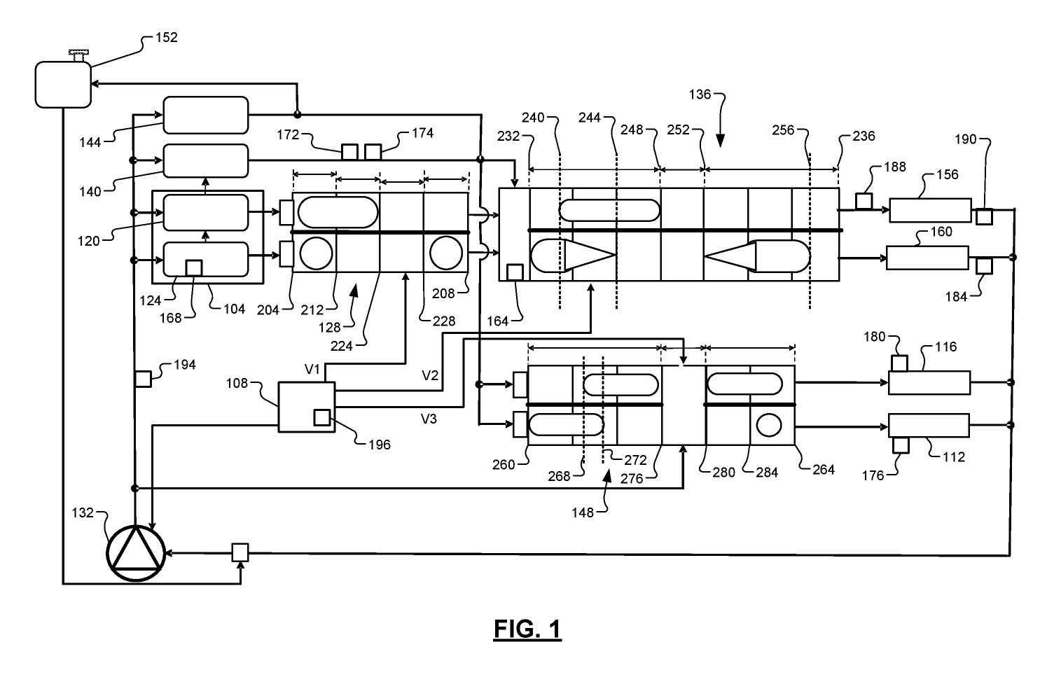

Referring now to FIG. 1, a functional block diagram of an example vehicle system is presented. An engine 104 combusts a mixture of air and fuel (e.g., diesel fuel or gasoline) within cylinders to generate drive torque. The engine 104 outputs torque to a transmission. The transmission transfers torque to one or more wheels of a vehicle via a driveline (not shown). An engine control module (ECM) 108 may control one or more engine actuators to regulate the torque output of the engine 104, for example, based on a target torque output of the engine 104.

An engine oil pump circulates engine oil through the engine 104 and a first heat exchanger 112. The first heat exchanger 112 may be referred to as an (engine) oil cooler or an oil heat exchanger (HEX). When the engine oil is cold, the first heat exchanger 112 may transfer heat to engine oil within the first heat exchanger 112 from coolant flowing through the first heat exchanger 112. When the engine oil is warm, the first heat exchanger 112 may transfer heat from the engine oil to coolant flowing through the first heat exchanger 112 and/or to air passing the first heat exchanger 112.

Viscosity of the engine oil is inversely related to temperature of the engine oil. That is, viscosity of the engine oil decreases as the temperature increases and vice versa. Frictional losses (e.g., torque losses) of the engine 104 associated with the engine oil may decrease as viscosity of the engine oil decreases and vice versa.

A transmission fluid pump circulates transmission fluid through the transmission and a second heat exchanger 116. The second heat exchanger 116 may be referred to as a transmission cooler or as a transmission heat exchanger. When the transmission fluid is cold, the second heat exchanger 116 may transfer heat to transmission fluid within the second heat exchanger 116 from coolant flowing through the second heat exchanger 116. When the transmission fluid is warm, the second heat exchanger 116 may transfer heat from the transmission fluid to coolant flowing through the second heat exchanger 116 and/or to air passing the second heat exchanger 116.

Viscosity of the transmission fluid is inversely related to temperature of the transmission fluid. That is, viscosity of the transmission fluid decreases as the temperature of the transmission fluid increases and vice versa. Losses (e.g., torque losses) associated with the transmission and the transmission fluid may decrease as viscosity of the transmission fluid decreases and vice versa.

The engine 104 includes a plurality of coolant channels through which engine coolant (“coolant”) can flow. For example, the engine 104 includes one or more coolant channels through the (cylinder) head portion 120 of the engine 104 and one or more coolant channels through the block portion 124 of the engine 104. The engine 104 may also include one or more other coolant channels through one or more other portions of the engine 104.

A coolant pump 132 pumps coolant to the coolant channels of the engine 104. The coolant pump 132 may be mechanically driven (e.g., by the engine 104). Alternatively, the coolant pump 132 may be an electric coolant pump. A first coolant valve (V1) 128 regulates coolant flow out of (and therefore through) the block portion 124 of the engine 104 and the head portion 120 of the engine 104.

The first coolant valve 128 may include a multiple-input, multiple-output valve that includes two or more separate chambers. For example, the first coolant valve 128 may include a rotary valve having a housing and a rotatable member inside of the housing. The rotating member includes channels or grooves that, for each of the separate chambers, regulate flow to one or more outputs of that chamber.

An example laid flat diagram of the first coolant valve 128 illustrating coolant flow to and from the first coolant valve 128 is provided in FIG. 1. The first coolant valve 128 (the rotatable member) can be actuated between two end positions 204 and 208. The first coolant valve 128 includes a first chamber (top in FIG. 1) and a second chamber (bottom in FIG. 1).

Coolant flows from the head portion 120 of the engine 104 to the first chamber and not the second chamber. Coolant flows from the block portion 124 of the engine 104 to the second chamber and not the first chamber. When the first chamber is receiving coolant, the first coolant valve 128 outputs coolant from the first chamber to a second coolant valve (V2) 136, which is discussed further below. When the second chamber is receiving coolant, the first coolant valve 128 outputs coolant from the second chamber to the second coolant valve 136.

When the first coolant valve 128 is positioned between the end position 204 and a first position 212, coolant flows through the head portion 120 of the engine 104 flows and into the first chamber and coolant flows through the block portion 124 of the engine 104 and into the second chamber. When the first coolant valve 128 is positioned between the first position 212 and a second position 224, coolant flows through the head portion 120 of the engine 104 flows into the first chamber. However, the first coolant valve 128 blocks coolant flow through the block portion 124 and the second chamber when the first coolant valve 128 is positioned between the first position 212 and the second position 224.

The first coolant valve 128 blocks coolant flow through the block portion 124 and the second chamber when the first coolant valve 128 is positioned between the second position 224 and a third position 228. The first coolant valve 128 also blocks coolant flow through the head portion 120 and the first chamber when the first coolant valve 128 is positioned between the second position 224 and the third position 228.

When the first coolant valve 128 is positioned between the third position 228 and the end position 208, coolant flows through the block portion 124 of the engine 104 and into the second chamber. However, the first coolant valve 128 blocks coolant flow through the head portion 120 and the first chamber when the first coolant valve 128 is positioned between the third position 228 and the end position 208. The shapes within the first coolant valve 128 illustrate examples of relative openings into the first and second chambers of the first coolant valve 128.

The coolant pump 132 also pumps coolant through an integrated exhaust manifold (IEM) 140 of the engine 104 and a turbocharger turbine 144 of the engine 104. The turbocharger turbine 144 drives rotation of a turbocharger compressor which increases airflow into the engine 104. Exhaust output by the engine 104 drives rotation of the turbocharger turbine 144.

Coolant flows from the IEM 140 to the second coolant valve 136 and a third coolant valve 148, which is discussed further below. Coolant also flows from the turbocharger turbine 144 to the second coolant valve 136 and the third coolant valve 148. Coolant may flow from the turbocharger turbine 144 into a reservoir (e.g., a surge tank) 152 under various circumstances, such as when the pressure of coolant output from the turbocharger turbine 144 is greater than a predetermined pressure.

The second coolant valve 136 receives coolant from the first coolant valve 128, the IEM 140, and the turbocharger turbine 144. The second coolant valve 136 regulates flow of the received coolant to a cabin heat exchanger (e.g., a heater core) 156 and a radiator heat exchanger 160.

The second coolant valve 136 may include a multiple-input, multiple-output valve that includes two or more separate chambers. The received coolant flows to both of the two chambers. For example, the second coolant valve 136 may include a rotary valve having a housing and a rotatable member inside of the housing. The rotating member includes channels or grooves that, for each of the separate chambers, regulate flow to one or more outputs of that chamber.

An example laid flat diagram of the second coolant valve 136 illustrating coolant flow to and from the second coolant valve 136 is provided in FIG. 1. The second coolant valve 136 (the rotatable member) can be actuated between two end positions 232 and 236. The second coolant valve 136 includes a first chamber (top in FIG. 1) and a second chamber (bottom in FIG. 1).

Received coolant flows from the first chamber to the cabin heat exchanger 156 when the first chamber is open. Received coolant flows from the second chamber to the radiator heat exchanger 160 when the second chamber is open.

When the second coolant valve 136 is positioned between the end position 232 and a first position 240, the first chamber of the second coolant valve 136 is closed and the second coolant valve 136 blocks coolant flow to the cabin heat exchanger 156. However, when the second coolant valve 136 is positioned between the end position 232 and the first position 240, the second chamber of the second coolant valve 136 is open and coolant flows through the second coolant valve 136 to the radiator heat exchanger 160.

When the second coolant valve 136 is positioned between the first position 240 and a second position 244, the first chamber of the second coolant valve 136 is open and coolant flows through the second coolant valve 136 to the cabin heat exchanger 156. When the second coolant valve 136 is positioned between the first position 240 and the second position 244, the second chamber of the second coolant valve 136 is also open and coolant flows through the second coolant valve 136 to the radiator heat exchanger 160.

When the second coolant valve 136 is positioned between the second position 244 and a third position 248, the first chamber of the second coolant valve 136 is open and coolant flows through the second coolant valve 136 to the cabin heat exchanger 156. However, when the second coolant valve 136 is positioned between the second position 244 and the third position 248, the second chamber of the second coolant valve 136 is closed and the second coolant valve 136 blocks coolant flow to the radiator heat exchanger 160.

When the second coolant valve 136 is positioned between the third position 248 and a fourth position 252, the first chamber and the second chamber are both closed. Thus, the second coolant valve 136 blocks coolant flow to the radiator heat exchanger 160 and the cabin heat exchanger 156.

When the second coolant valve 136 is positioned between the fourth position 252 and a fifth position 256, the first chamber of the second coolant valve 136 is closed and the second coolant valve 136 blocks coolant flow to the cabin heat exchanger 156. However, when the second coolant valve 136 is positioned between the fourth position 252 and the fifth position 256, the second chamber of the second coolant valve 136 is open and coolant flows through the second coolant valve 136 to the radiator heat exchanger 160. The shapes within the second coolant valve 136 illustrate examples of relative openings from the first and second chambers of the second coolant valve 136.

The third coolant valve 148 receives coolant from the IEM 140 and the turbocharger turbine 144. The third coolant valve 148 regulates flow of the received coolant to the second heat exchanger 116 and the first heat exchanger 112.

The third coolant valve 148 may include a multiple-input, multiple-output valve that includes two or more separate chambers. The received coolant flows to both of the two chambers. For example, the third coolant valve 148 may include a rotary valve having a housing and a rotatable member inside of the housing. The rotating member includes channels or grooves that, for each of the separate chambers, regulate flow to one or more outputs of that chamber.

An example laid flat diagram of the third coolant valve 148 illustrating coolant flow to and from the third coolant valve 148 is also provided in FIG. 1. The third coolant valve 148 (the rotatable member) can be actuated between two end positions 260 and 264. The third coolant valve 148 includes a first chamber (top in FIG. 1) and a second chamber (bottom in FIG. 1).

Received coolant flows from the first chamber to the second heat exchanger 116 when the first chamber is open. Received coolant flows from the second chamber to the first heat exchanger 112 when the second chamber is open.

When the third coolant valve 148 is positioned between the end position 260 and a first position 268, the first chamber of the second coolant valve 136 is closed and the third coolant valve 148 blocks coolant flow to the second heat exchanger 116. However, when the third coolant valve 148 is positioned between the end position 260 and the first position 268, the second chamber of the third coolant valve 148 is open and coolant flows through the third coolant valve 148 to the first heat exchanger 112.

When the third coolant valve 148 is positioned between the first position 268 and a second position 272, the first chamber of the third coolant valve 148 is open and coolant flows through the third coolant valve 148 to the second heat exchanger 116. When the third coolant valve 148 is positioned between the first position 268 and the second position 272, the second chamber of the third coolant valve 148 is also open and coolant flows through the third coolant valve 148 to the first heat exchanger 112.

When the third coolant valve 148 is positioned between the second position 272 and a third position 276, the first chamber of the third coolant valve 148 is open and coolant flows through the third coolant valve 148 to the second heat exchanger 116. However, when the third coolant valve 148 is positioned between the second position 272 and the third position 276, the second chamber of the third coolant valve 148 is closed and the third coolant valve 148 blocks coolant flow to the first heat exchanger 112.

The third coolant valve 148 may also receive coolant output by the coolant pump 132. When the third coolant valve 148 is positioned between the third position 276 and a fourth position 280, the third coolant valve 148 blocks coolant flow from the IEM 140 and the turbocharger turbine 144 to the first and second heat exchangers 112 and 116. However, when the third coolant valve 148 is positioned between the third position 276 and the fourth position 280, coolant output by the coolant pump 132 may flow through the third coolant valve 148 to the first and second heat exchangers 112 and 116.

When the third coolant valve 148 is positioned between the fourth position 280 and a fifth position 284, the first chamber of the third coolant valve 148 is open and coolant flows through the third coolant valve 148 to the second heat exchanger 116. However, when the third coolant valve 148 is positioned between the fourth position 280 and the fifth position 284, the second chamber of the third coolant valve 148 is closed and the third coolant valve 148 blocks coolant flow to the first heat exchanger 112.

When the third coolant valve 148 is positioned between the end position 264 and the fifth position 284, the first chamber of the third coolant valve 148 is opened at some positions and the third coolant valve 148 allows coolant to flow to the second heat exchanger 116. However, when the third coolant valve 148 is positioned between the end position 264 and the fifth position 284, the second chamber of the third coolant valve 148 is open at some positions and coolant flows through the third coolant valve 148 to the first heat exchanger 112.

The first, second, and third coolant valves 128, 136, and 148 may be referred to as active thermostat valves. Unlike passive thermostat valves which automatically open and close when a coolant temperature is greater than and less than a predetermined temperature, respectively, active thermostat valves are electrically actuated.

The cabin heat exchanger 156 transfers heat from coolant flowing through the cabin heat exchanger 156 to air passing the cabin heat exchanger 156 to warm a passenger cabin of the vehicle. The radiator heat exchanger 160 transfers heat from coolant flowing through the radiator heat exchanger 160 to air passing the radiator heat exchanger 160 to cool the coolant. Cooled coolant can be used to cool the engine 104 and other vehicle components.

When the engine oil is cold, the first heat exchanger 112 can transfer heat from coolant flowing through the first heat exchanger 112 to the engine oil. When the engine oil is warm, the first heat exchanger 112 can transfer heat from the engine oil to air passing the first heat exchanger 112 and/or coolant flowing through the first heat exchanger 112. When the transmission oil is cold, the second heat exchanger 116 can transfer heat from coolant flowing through the second heat exchanger 116 to the transmission oil. When the transmission oil is warm, the second heat exchanger 116 can transfer heat from the transmission oil to air passing the second heat exchanger 116 and/or coolant flowing through the second heat exchanger 116.

A first coolant temperature sensor 164 measures a first temperature of coolant input to the second coolant valve 136. A block temperature sensor 168 measures a temperature of the block (metal) portion 124 of the engine 104. A head temperature sensor 172 measures a temperature of the head (metal) portion 120 of the engine 104. A head pressure sensor 174 may be implemented and measure a pressure of the coolant in the head (metal) portion 120 of the engine 104.

An engine oil temperature sensor 176 measures a temperature of the engine oil, such as within the first heat exchanger 112. A transmission oil temperature sensor 180 measures a temperature of the transmission oil, such as within the second heat exchanger 116.

A second coolant temperature sensor 184 measures a second temperature of coolant output from the radiator heat exchanger 160. A third coolant temperature sensor 188 measures a third temperature of coolant input to the cabin heat exchanger 156. A fourth coolant temperature sensor 190 measures a fourth temperature of coolant output from the cabin heat exchanger 156. A fifth coolant temperature sensor 194 measures a fifth temperature of coolant output from the coolant pump 132 and input to the head portion 120, the block portion 124, the IEM 140, and the turbocharger turbine 144.

One or more other sensors may also be implemented, such as one or more other coolant temperature sensors, a crankshaft position sensor, a mass air flowrate (MAF) sensor, a manifold absolute pressure (MAP) sensor, and/or one or more other suitable vehicle sensors.

The sensors may provide signals indicative of the respective measurements to the ECM 108. Based at least partially on one or more of the measurements provided by the sensors, a coolant control module 196 controls a speed of the coolant pump 132, the position of the first coolant valve 128, the position of the second coolant valve 136, and the position of the third coolant valve 148 collectively using model predictive control (MPC). While the example of the coolant control module 196 being implemented within the ECM 108 is shown, the coolant control module 196 may be implemented within another module or independently.

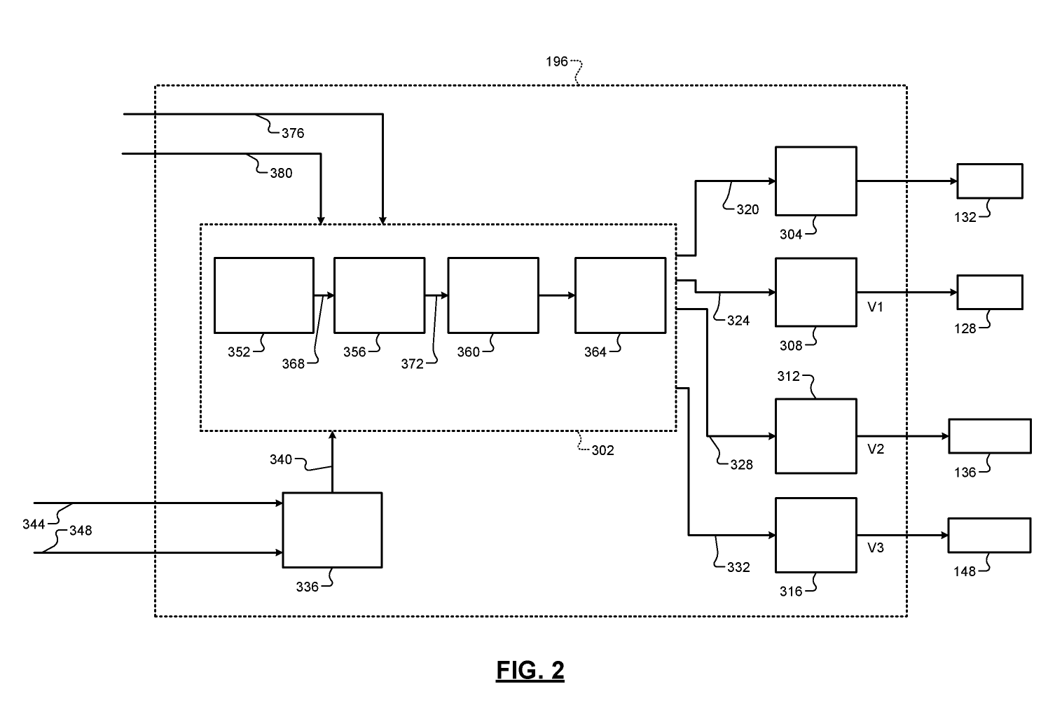

Referring now to FIG. 2, a functional block diagram of an example implementation of the coolant control module 196 is presented. The coolant control module 196 includes a model predictive control (MPC) module 302, a pump control module 304, a first valve control module 308, a second valve control module 312, and a third valve control module 316. Using MPC, the MPC module 302, collectively determines a target speed 320 of the coolant pump 132, a target position 324 of the first coolant valve 128, a target position 328 of the second coolant valve 136, and a target position 332 of the third coolant valve 148.

The pump control module 304 controls a speed of the coolant pump 132 based on or to the target speed 320. For example, the pump control module 304 may determine characteristics of power to apply to the electric motor of the coolant pump 132 based on the target speed 320 and apply power to the electric motor accordingly. The first valve control module 308 actuates the first coolant valve 128 based on or to the target position 324. The second valve control module 312 actuates the second coolant valve 136 based on or to the target position 328. The third valve control module 316 actuates the third coolant valve 148 based on or to the target position 332.

A reference module 336 determines reference parameters 340 that are used in determining the target speed 320, the target position 324, the target position 328, and the target position 332. The reference module 336 may determine the reference parameters 340 based on an engine speed 344, fueling 348 of the engine 104, and/or one or more other parameters. For example, the reference module 336 may determine the reference parameters 340 using one or more equations and/or lookup tables that relate engine speeds and fueling amounts to sets of reference parameters.

In various implementations, one or more of the reference parameters may be fixed, predetermined values. For example, a reference efficiency may be a fixed, predetermined maximum value. In view of the below, the use of a predetermined maximum value may improve efficiency. As another example, one or more reference coolant temperatures at respective locations may be set to predetermined temperatures (e.g., 200 degrees Fahrenheit or another temperature). The predetermined temperatures may be defined to avoid boiling of the coolant and based on best efficiency for the system in steady-state (e.g., transmission oil target temperature to minimize losses).

The engine speed 344 may be measured using a sensor. For example, a crankshaft position sensor may determine positions of a crankshaft of the engine 104 as the crankshaft rotates, and the engine speed 344 may be measured based on a change between two positions and the period between when the crankshaft was in the two positions. The fueling 348 may be, for example, a commanded mass of fuel provided to a cylinder of the engine 104. A fuel control module of the vehicle may actuate a fuel injector based on the fueling 348.

As stated above, the MPC (model predictive control) module 302 generates the target values 320-332 using MPC. The MPC module 302 may be a single module or may comprise multiple modules. For example, the MPC module 302 may include a sequence determination module 352, a prediction module 356, a cost module 360, and a selection module 364.

The sequence determination module 352 determines possible sequences 368 of the target values 320-332 that could be used together during N future control loops. Each of the possible sequences 368 identified by the sequence determination module 352 includes one sequence of N values for each of the target values 320-332. In other words, each possible sequence includes a sequence of N values for the target speed 320, a sequence of N values for the target position 324, a sequence of N values for the target position 328, a sequence of N values for the target position 332. Each of the N values is for a corresponding one of the N future control loops. N is an integer equal or greater than one. The period of time defined by the N future control loops may be referred to as a prediction horizon.

In another example, the sequence determination module 352 determines the possible sequences 368 of the target values 320-332 that could be used together during M future control loops and keep them constant from the next control loop (M+1) to the last one of the future control loops (N). The period of time defined by the M future control loops may be referred to as control horizon. M is an integer equal or less than N. As such, the prediction horizon is greater than or equal to the control horizon.

The prediction module 356 determines predicted parameters 372 for the possible sequences 368 of the target values 320-332, respectively, based on mathematical models, as discussed further below. The predicted parameters 372 for a possible sequence of target values are values of various parameters that are predicted to result from the use of that possible sequence of target values. Each of the mathematical models may include, for example, a function or a mapping calibrated based on characteristics of the coolant pump 132, the first coolant valve 128, the second coolant valve 136, and the third coolant valve 148.

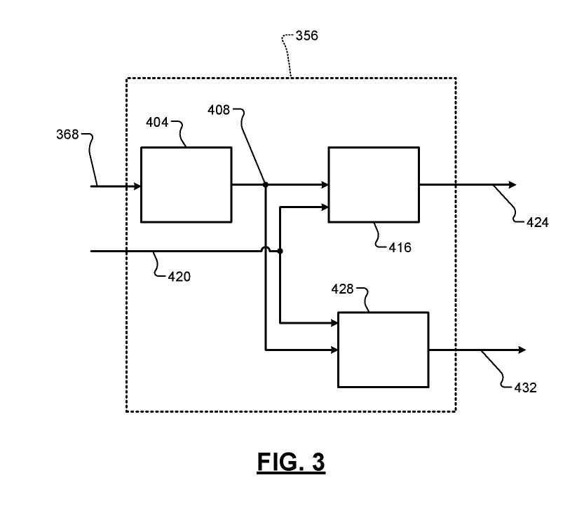

FIG. 3 includes a functional block diagram of an example implementation of the prediction module 356. Referring now to FIGS. 2 and 3, based on a possible sequence of the target values 320-332, using a first model, a flowrate prediction module 404 generates Z sequences of N predicted coolant (mass) flowrates 408 for M future control loops. The first model is a non-linear model that is linearized each control loop online by the prediction module 356.

The flowrate prediction module 404 determines the Z sequences of N predicted coolant flowrates based on the respective possible sequences 368 of the target values 320-332. Z is equal to a number of different coolant branches through which coolant can flow. One example coolant branch includes the passages through which coolant flows through the head portion 120 of the engine 104. Another example coolant branch includes the passages through which coolant flows through the block portion 124 of the engine 104. Another example coolant branch includes the passages through which coolant flows through the IEM 140. Another example coolant branch includes the passages through which coolant flows through the turbocharger turbine 144. Another example coolant branch includes the passages through which coolant flows through the cabin heat exchanger 156. Another example coolant branch includes the passages through which coolant flows through the radiator heat exchanger 160. Another example coolant branch includes the passages through which coolant flows through the first heat exchanger 112. Another example coolant branch includes the passages through which coolant flows through the second heat exchanger 116. While these example branches are provided, additional coolant branches may be considered.

A temperature prediction module 416, based on a possible sequence of predicted flowrates 408 and one or more disturbance parameters 420, using a second mathematical model, determines B sequences of N predicted temperatures 424 for the N future control loops. The disturbance parameters 420 are parameters that can cause changes in one or more of the predicted temperatures. Each of the B sequences is for a different predicted temperature at a different location over the N future control loops. For example, based on the possible sequence of predicted flowrates 408 and the one or more disturbance parameters 420, the temperature prediction module 416 may determine a sequence of predicted values of the fifth temperature measured by the fifth coolant temperature sensor 194, a sequence of predicted values of the first temperature measured by the first coolant temperature sensor 164, a sequence of predicted values of the head temperature measured by the head temperature sensor 172, a sequence of predicted values of the block temperature measured by the block temperature sensor 168, a sequence of predicted values of the third coolant temperature measured by the third coolant temperature sensor 188, a sequence of predicted values of the fourth coolant temperature measured by the fourth coolant temperature sensor 190, a sequence of predicted values of the second coolant temperature measured by the second coolant temperature sensor 184, a sequence of predicted values of the transmission oil temperature measured by the transmission oil temperature sensor 180, a sequence of predicted values of the engine oil temperature measured by the engine oil temperature sensor 176, a sequence of predicted values of a temperature of walls of the block portion 124 of the engine 104, and a sequence of predicted values of a temperature of a portion of the head portion 120 of the engine 104. The temperature prediction module 416 determines a sequence of N predicted temperatures 424 for the N future control loops for each of the possible sequences of predicted flowrates 408 based on that possible sequence of predicted flowrates 408. The second model is a non-linear model that is linearized each control loop online by the prediction module 356.

The disturbance parameters 420 may include, for example, a temperature of exhaust gas, a temperature of the turbocharger, a temperature of recirculated exhaust gas, the engine speed 344, a mass of air per cylinder (APC) of the engine 104, and the fueling 348.

An efficiency prediction module 428, based on a possible sequence of N predicted flowrates 408, the respective sequences of N predicted temperatures 424, and the one or more disturbance parameters 420, using a third mathematical model, determines a sequence of N predicted efficiencies 432 for the N future control loops. The predicted efficiencies may be, for example, values reflecting efficiency of the engine 104 under the operating conditions where, for example, higher efficiency values correspond to higher efficiencies (and a lower fuel consumption rates) and lower efficiency values correspond to lower efficiencies (and a higher fuel consumption rates). Alternatively, the predicted efficiencies may be expressed in terms of differences between predicted fuel consumption rates of the engine 104 and reference fuel consumption rates for the operating conditions. The efficiency prediction module 428 determines a sequence of N predicted efficiencies for the N future control loops for each of the possible sequences of predicted flowrates 408 based on that possible sequence of predicted flowrates 408 and the respective predicted sequences of predicted temperatures 424. The third model is a non-linear model that is linearized each control loop online by the prediction module 356. Collectively, the sequences of N predicted efficiencies 432 and the sequences of N predicted temperatures 424 make up the predicted parameters 372.

Referring back to FIG. 2, the cost module 360 determines a cost value for each of the possible sequences of the target values 320-332 based on the predicted parameters 372 determined for that possible sequence. An example cost determination is discussed further below.

The selection module 364 selects one of the possible sequences of the target values 320-332 based on the costs of the possible sequences, respectively. For example, the selection module 364 may select the one of the possible sequences having the lowest cost while satisfying actuator constraints 380 and output constraints 376.

Satisfaction of output constraints 376 may be considered in the cost determination. In other words, the cost module 360 may determine the cost values based on the output constraints 376. As discussed further below, based on how the cost values are determined, the selection module 364 will select the one of the possible sequences that achieves a highest efficiency while satisfying actuator constraints 380 and the output constraints 376.

The selection module 364 may set the target values 320-332 to the first ones of the N values of the selected possible sequence, respectively. In other words, the selection module 364 sets the target speed 320 to the first one of the N values in the sequence of N values for the target speed 320, set the target position 324 to the first one of the N values in the sequence of N values for the target position 324, set the target position 328 to the first one of the N values in the sequence of N values for the target position 328, and set the target position 332 to the first one of the N values in the sequence of N values for the target position 332.

During a next control loop, the MPC module 302 identifies possible sequences of the target values 320-332, generates the predicted parameters for the possible sequences, determines the cost of each of the possible sequences, selects one of the possible sequences, and sets of the target values 320-332 to the first set of the target values 320-332 in the selected possible sequence. This process continues for each control loop.

The actuator constraints 380 for one of the target values 320-332 may include a maximum value for an associated target value and a minimum value for that target value. The actuator constraints 380 may be set to predetermined values for the respective associated actuators (i.e., the coolant pump 132 and the coolant valves 128, 136, and 148). The output constraints 376 include a maximum and a minimum values for each of the predicted parameters 372. For example, the output constraints 376 include a maximum first coolant temperature and a minimum first coolant temperature.

The MPC module 312 may identify the sequence of possible target values having the lowest cost using convex optimization techniques. For example, the MPC module 302 may determine the target values 320-332 using a quadratic programming (QP) solver, such as a Dantzig QP solver.

The cost module 360 may generate a surface of cost values for the possible sequences of the target values 320-332 based on comparisons of the predicted parameters 372 with the respective reference parameters 340 and the respective output constraints 376. The selection module 364 may identify a point on the cost surface where the slope satisfies predetermined criteria (e.g., greater than a predetermined slope or less than a predetermined slope). That point may correspond to a sequence of possible target values having the lowest cost. This sequence of possible target values may provide the predicted parameters 372 that are closest to the respective reference parameters 340 and within the respective output constraints 376.

The selection module 364 may then test that sequence of possible target values to determine whether that sequence of possible target values satisfies the actuator constraints 380. If the actuator constraints 380 are not satisfied, the selection module 364 selects another sequence of possible target values with a next lowest cost and tests that sequence of possible target values for satisfaction of the actuator constraints 380. The process of selecting a sequence and testing the sequence for satisfaction of the actuator constraints 380 may be referred to as an iteration. Multiple iterations may be performed during each control loop.

The selection module 364 performs iterations until a sequence with the lowest cost that satisfies the actuator constraints 380 is identified. In this manner, the selection module 364 selects the sequence of possible target values having the lowest cost while satisfying the actuator constraints 380.

The cost module 360 may determine the cost for the possible sequences of the target values 320-332 based on relationships between: the predicted parameters 372 and the respective reference parameters 340. The relationships may be weighted, for example, to control the effect that each of the relationships has on the cost.

For example only, the cost module 360 may determine the cost for a possible sequence of the target values 320-332 based on the following equation:

Cost=Σᵢ₌₁^{N}ρϵ²+∥wE*(PEᵢ−REᵢ)∥²+∥w1*(PP1ᵢ−R1ᵢ)∥²+∥w2*(PP2ᵢ−R2ᵢ)∥²+ . . . ,

subject to the actuator constraints 380 and the output constraints 376. Cost is the cost (value) for the possible sequence of the target values 220-332, wE is a weighing value associated with the relationship between predicted efficiency and the reference efficiency, PEi is the predicted efficiency for the next control loop (i.e., i=1), REi is the reference efficiency for the next control loop (i.e., i=1), w1 is a first weighing value associated with the relationship between a first other one of the predicted parameters and a first reference for that one of the predicted parameters, PP1i is the first other one of the predicted parameters for the next control loop (i.e., i=1), R1i is the first reference for that one of the predicted parameters, w2 is a second weighing value associated with the relationship between a second other one of the predicted parameters and a second reference for that one of the predicted parameters, PP2i is the second other one of the predicted parameters for the next control loop (i.e., i=1), and R2i is the second reference for that one of the predicted parameters, and so on for the remainder of the predicted parameters and the respective reference parameters.

ρ is a weighting value associated with satisfaction of the output constraints 376. If the cost module 360 (e.g., a QP solver) is not able to find a viable solution within the constraints' boundaries, for example due to model errors, the cost module 360 adjusts the output constrains 376 by ϵ in order to explore a wider area and find a solution that is within the constraints. In order to keep ϵ small (to satisfy the constraints as much as possible) ρ has a higher value than the other weights wE, w1, w2, etc. ρ and ϵ may be used only in presence of the output constraints.

The weighting values may be fixed. In various implementations, the cost module 360 may vary one or more of the weighting values under some circumstances.

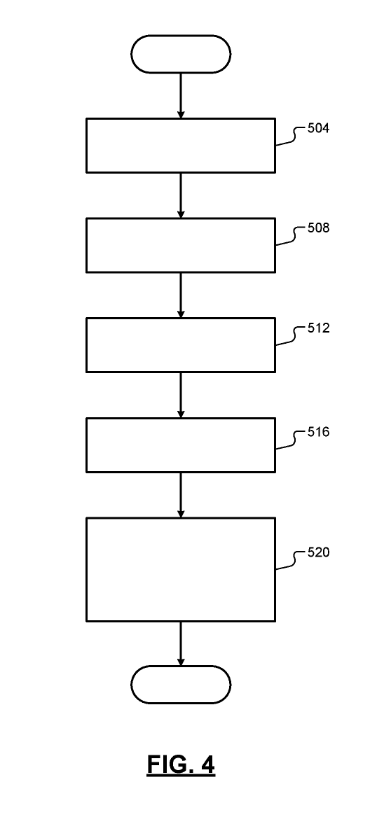

FIG. 4 is a flowchart depicting an example method of controlling the first coolant valve 128, the second coolant valve 136, the third coolant valve 148, and the coolant pump 132. Control may begin with 504 where the sequence determination module 352 determines the possible sequences 368 of the target values 320-332. In various implementations, the possible sequences 368 may be a fixed set of possible sequences of the target values 320-332. The possible sequences 368 may be calibrated and selected such that the possible sequences of the target values 320-332 do not violate any of the actuator constraints 380.

At 508, the prediction module 356 determines the predicted parameters 372 for the possible sequences 368 based on the possible sequences 368, respectively. More specifically, the flowrate prediction module 404 determines the predicted flowrates 408 for the possible sequences 368 based on the possible sequences 368, respectively, using the first model. The temperature prediction module 416 determines the N predicted temperatures 424 for the possible sequences 368 based on the predicted flowrates 408 of the possible sequences 368, respectively, and the disturbance parameters 420 using the second model. The efficiency prediction module 428 determines the N predicted efficiencies 432 for the possible sequences 368 based on the predicted flowrates 408 of the possible sequences 368, respectively, the predicted temperatures 424 of the possible sequences 368, respectively, and the disturbance parameters 420 using the third model.

At 512, the cost module 360 determines the costs for the possible sequences 368, respectively, based on comparisons of the respective predicted parameters 372 of the possible sequences 368 and the reference parameters 340. The cost module 360 may also determine the costs based on satisfaction of the output constraints 376. Because the cost of a possible sequence is based on comparison of the possible sequence's predicted efficiencies and the reference efficiency, the cost of the possible sequence will increase as predicted efficiency moves away from the reference efficiency. As a possible sequence's cost increases, a probability of that possible sequence being selected and used to control the first coolant valve 128, the second coolant valve 136, the third coolant valve 148, and the coolant pump 132 decreases.

At 516, the selection module 364 selects one of the possible sequences 368 of the target values 320-332 based on the costs of the possible sequences 368, respectively. For example, the selection module 364 may select the one of the possible sequences 368 having the lowest cost. The selection module 364 may therefore select the one of the possible sequences that is predicted to more closely achieve the reference efficiency while satisfying the output constraints 376. The selection module 364 sets the target values 320-332 to the first ones of the N values of the selected possible sequence, respectively, as discussed above.

At 520, the pump control module 304 applies power to the coolant pump 132 to adjust the speed of the coolant pump 132 based on or to the target speed 320. The first valve control module 308 actuates the first coolant valve 128 based on or to the target position 324. The second valve control module 312 actuates the second coolant valve 136 based on or to the target position 328. The third valve control module 316 actuates the third coolant valve 148 based on or to the target position 332.

While FIG. 4 is shown as ending, FIG. 4 may be illustrative of one control loop, and control loops may be executed at a predetermined rate. Also, the order of operations provided and discussed with FIG. 4 are an example and operations may be performed in a different order.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A coolant control system of a vehicle, comprising:
a prediction module configured to, based on a set of possible target values for M future times, determine M predicted efficiency values for set of possible target values at the M future times, respectively,
wherein M is an integer greater than or equal to one;
a cost module configured to determine a cost for the set of possible target values based on comparisons of the M predicted efficiency values and a reference efficiency value;
a selection module configured to:
based on the cost of the set of possible target values, select the set of possible target values from a group including:
the set of possible target values; and
N other sets of possible target values,
wherein N is an integer greater than zero; and
set target values to respective ones of the selected set of possible target values; and
a first valve control module configured to actuate a first coolant valve based on a first one of the target values,
wherein the first coolant valve is configured to control coolant flow through a portion of a coolant system of the vehicle.

2. The coolant control system of claim 1 further comprising:
a second valve control module configured to actuate a second coolant valve based on a second one of the target values;
a third valve control module configured to actuate a third coolant valve based on a third one of the target values; and
a pump control module configured to apply power to an electric coolant pump based on a fourth one of the target values.

3. The coolant control system of claim 2 wherein the first coolant valve is configured to regulate coolant flow through at least one of:
an engine block portion of an internal combustion engine of the vehicle; and
a cylinder head portion of the internal combustion engine of the vehicle.

4. The coolant control system of claim 2 wherein the first coolant valve is configured to regulate coolant flow both of:
an engine block portion of an internal combustion engine of the vehicle; and
a cylinder head portion of the internal combustion engine of the vehicle.

5. The coolant control system of claim 4 wherein the second coolant valve is configured to regulate coolant flow to at least one of:
a radiator heat exchanger; and
a passenger cabin heat exchanger.

6. The coolant control system of claim 4 wherein the second coolant valve is configured to regulate coolant flow to both of:
a radiator heat exchanger; and
a passenger cabin heat exchanger.

7. The coolant control system of claim 6 wherein the third coolant valve is configured to regulate coolant flow to at least one of:
a transmission oil heat exchanger; and
an engine oil heat exchanger.

8. The coolant control system of claim 6 wherein the third coolant valve is configured to regulate coolant flow to both of:
a transmission oil heat exchanger; and
an engine oil heat exchanger.

9. The coolant control system of claim 1 wherein the selection module is configured to select the set of possible target values from the group in response to a determination that the cost of the set of possible target values is less than all of N costs of the N other sets of possible target values, respectively.

10. The coolant control system of claim 9 wherein the cost module is configured to increase the cost of the set of possible target values as a difference between one of the M predicted efficiency values and the reference efficiency value increases.

11. The coolant control system of claim 9 wherein the cost module is configured to increase the cost of the set of possible target values as a magnitude of a difference between one of the M predicted efficiency values and the reference efficiency value increases.

12. The coolant control system of claim 9 wherein the reference efficiency value is a fixed, predetermined value.

13. The coolant control system of claim 1 wherein the prediction module is configured to:
based on the set of possible target values for M future times, using a first mathematical model, determine N predicted coolant flowrates through N different branches of the coolant system through which coolant can flow at the M future times,
wherein N is an integer greater than one; and
based on the N predicted coolant flowrates at the M future times, determine the M predicted efficiency values for the set of possible target values using a second mathematical model.

14. The coolant control system of claim 13 wherein the first mathematical model relates sets of the possible target values to sets of the N predicted coolant flowrates.

15. The coolant control system of claim 13 wherein the second mathematical model relates sets of the N predicted coolant flowrates to individual predicted efficiency values.

16. The coolant control system of claim 1 wherein:
the prediction module is further configured to, based on the set of possible target values for the M future times, determine M predicted coolant temperatures at a location within the coolant system for the M future times, respectively; and
the cost module is configured to determine the cost for the set of possible target values further based on comparisons of the M predicted coolant temperatures and a reference coolant temperature at the location.

17. The coolant control system of claim 16 wherein the reference coolant temperature is a predetermined amount less than a boiling point temperature of the coolant.

18. The coolant control system of claim 16 wherein the prediction module is configured to:
based on the set of possible target values for M future times, using a first mathematical model, determine N predicted coolant flowrates through N different branches of the coolant system through which coolant can flow at the M future times; and
based on the N predicted coolant flowrates at the M future times, using a second mathematical model, determine the M predicted coolant temperatures for the set of possible target values.

19. The coolant control system of claim 18 wherein:
the first mathematical model relates sets of the possible target values to sets of the N predicted coolant flowrates; and
the second mathematical model relates sets of the N predicted coolant flowrates to individual predicted coolant temperatures.

20. A coolant control method for a vehicle, comprising:
based on a set of possible target values for M future times, determining M predicted efficiency values for set of possible target values at the M future times, respectively,
wherein M is an integer greater than or equal to one;
determining a cost for the set of possible target values based on comparisons of the M predicted efficiency values and a reference efficiency value;
based on the cost of the set of possible target values, selecting the set of possible target values from a group including:
the set of possible target values; and
N other sets of possible target values,
wherein N is an integer greater than zero; and
setting target values to respective ones of the selected set of possible target values; and
actuating a first coolant valve based on a first one of the target values,
wherein the first coolant valve is configured to control coolant flow through a portion of a coolant system of the vehicle.
